(19) United States
(12) Patent Application Publication
(10) Pub. No.: US 2024/0169567 A1
(43) Pub. Date: May 23, 2024

(54) DEPTH EDGES REFINEMENT FOR SPARSELY SUPERVISED MONOCULAR DEPTH ESTIMATION

(71) Applicant: SAMSUNG ELECTRONICS CO., LTD., SUWON-SI (KR)

(72) Inventors: Lior Talker, Tel-Aviv (IL); Alexandra Dana, Tel-Aviv (IL); Aviad Cohen, Tel-Aviv (IL); Erez Yosef, Tel-Aviv (IL); Michael Dinerstein, Tel-Aviv (IL); Amir Ben-Dror, Tel-Aviv (IL)

(21) Appl. No.: 18/354,039

(22) Filed: Jul. 18, 2023

Related U.S. Application Data
(60) Provisional application No. 63/423,622, filed on Nov. 8, 2022.

(51) Int. Cl. G06T 7/50; G06T 7/13

(52) U.S. Cl. CPC G06T 7/50; G06T 7/13; G06T 2207/20084

(57) ABSTRACT

Systems and methods for depth estimation are provided. One aspect of the systems and methods includes obtaining an image. Another aspect of the systems and methods includes generating a depth map of the image using a monocular depth estimation (MDE) network, where the MDE network is trained using training data including edge data generated by a depth edge estimation (DEE) network.

### CROSS-REFERENCE TO RELATED APPLICATIONS

This application claims priority under 35 USC § 119(a) to U.S. Patent Application No. 63/423,622 filed on Nov. 8, 2022, the disclosure of which is incorporated by reference herein in its entirety.

### BACKGROUND

The following relates generally to machine learning, and more specifically to machine learning for depth estimation.

Monocular depth estimation (MDE) may refer to the prediction, from a single image (e.g., an RGB image), of a depth map for the image or the estimation of the depth of each pixel of an RGB image. The ability to perform depth estimation on images may be crucial in navigation applications (e.g., autonomous driving, in order to detect and avoid collisions, and to continuously learn from an environment). MDE may also be used in graphical applications, such as novel view synthesis (NVS), where a view of a scene, which was not captured beforehand, is generated from a set of other views. Another example of a graphical application that uses depth is occlusion mask computation in augmented reality (AR) applications.

### SUMMARY

The present disclosure describes systems and methods for depth estimation. Embodiments of the present disclosure include a monocular depth estimation (MDE) network configured to generate a depth map for an image depicting the depths of different pixels in the image. The MDE network may be trained using ground truth depth data and ground truth edge data associated with a set of training images. A depth edge estimation (DEE) network may generate the ground truth edge data (e.g., pseudo ground truth edge data) for the training images. During training, the MDE network may generate a depth map for an image, and an edge detection block (EDB) may generate predicted edge data based on the depth map. The depth map may be compared to the ground truth depth data to compute a depth loss, and the predicted edge data may be compared to the pseudo ground-truth edge data to compute an edge loss. The MDE network may then be trained based on the depth loss and the edge loss.

A method, apparatus, non-transitory computer readable medium, and system for machine learning for depth estimation are described. One or more aspects of the method, apparatus, non-transitory computer readable medium, and system include obtaining an image and generating a depth map of the image using a MDE network, wherein the MDE network is trained using training data including edge data generated by a DEE network.

A method, apparatus, non-transitory computer readable medium, and system for machine learning for depth estimation are described. One or more aspects of the method, apparatus, non-transitory computer readable medium, and system include obtaining training data including pseudo ground-truth edge data generated by a DEE network and training a MDE network to generate a depth map using the training data.

An apparatus, system, and method for machine learning for depth estimation are described. One or more aspects of the apparatus, system, and method include at least one memory component; at least one processing device coupled to the at least one memory component, wherein the at least one processing device is configured to execute instructions stored in the at least one memory component; and a MDE network configured to generate a depth map of an image, wherein the MDE network is trained using training data including edge data generated by a DEE network.

### BRIEF DESCRIPTION OF THE DRAWINGS

FIG. 1 shows an example of a depth estimation system according to aspects of the present disclosure.

FIG. 2 shows an example of a method for depth estimation according to aspects of the present disclosure.

FIG. 3 shows example results of depth estimation according to aspects of the present disclosure.

FIG. 4 shows an example of training and inference processes for depth estimation according to aspects of the present disclosure.

FIG. 5 shows an example of a depth estimation apparatus according to aspects of the present disclosure.

FIG. 6 shows an example of a monocular depth estimation (MDE) network during training according to aspects of the present disclosure.

FIG. 7 show an example of a depth edge estimation (DEE) network during training according to aspects of the present disclosure.

FIGS. 8 through 9 show examples of methods for machine learning according to aspects of the present disclosure.

### DETAILED DESCRIPTION

The present disclosure describes systems and methods for depth estimation. Embodiments of the present disclosure include a monocular depth estimation (MDE) network configured to generate a depth map for an image depicting the depths of different pixels in the image. The MDE network may be trained using ground truth depth data and ground truth edge data associated with a set of training images. A depth edge estimation (DEE) network may generate the ground truth edge data (e.g., pseudo ground truth edge data) for the training images. During training, the MDE network may generate a depth map for an image, and an edge detection block (EDB) may generate predicted edge data based on the depth map. The depth map may be compared to the ground truth depth data to compute a depth loss, and the predicted edge data may be compared to the pseudo ground-truth edge data to compute an edge loss. The MDE network may then be trained based on the depth loss and the edge loss.

MDE aims to recover the depth of each pixel in a single RGB image. MDE may be used in various applications, such as robotic navigation, novel view synthesis (NVS), and augmented reality (AR). In some aspects, however, MDE may be an ill-posed problem, since it may be possible for a single RGB image to be generated from many possible scenes. Nonetheless, many MDE methods based on convolutional neural networks (CNNs) have shown remarkable results. CNN-based supervised methods may be trained with ground truth depth data which is usually dense for indoor scenes (e.g., acquired using an RGBD camera) and sparse for outdoor scenes (e.g., acquired using a light detection and ranging (LIDAR)) sensor.

In some implementations of an MDE network, the two-dimensional (2D) locations of depth edges (e.g., depth discontinuities) may be poorly estimated, resulting in thick, smooth depth gradients or incorrectly localized edges. Some applications that use predicted depth maps may be highly sensitive to errors in depth edges, which are often part of the silhouette of objects. One example of such an application is NVS—generating a new view of a scene captured from multiple views. In NVS methods that use depth explicitly, localization errors in the 2D location of depth edges may result in wrongly localized object parts in another newly generated view. Another application that often uses predicted depth is virtual object rendering for AR, which computes for each pixel the closest occluding object from the point of view of a user. When relying on inaccurate depth edges in the computation of the occlusion, significant artifacts and unrealistic appearance may occur.

The underlying reasons for the difficulty in properly reconstructing depth edges may be presumably twofold. The first is the small impact of the depth edges on a loss computed for an MDE network during training, since depth edges may occupy a small portion of an image. The second is due to alignment errors between an RGB image (e.g., a training image) and a LIDAR image or signal (e.g., an image used to compute the ground-truth depth map for a training image). Specifically, LIDAR measurements are often wrongly associated with objects although belonging to the background, or LIDAR measurements are absent in occluded areas that are revealed in the time gap between the RGB and the LIDAR data acquisition. Thus, regions close to depth edges may suffer from a lower density of LIDAR measurements.

The present disclosure proposes to improve the accuracy of depth edges in a predicted depth map computed using MDE by directly encouraging the depth edges of the predicted depth map to be well-localized. If ground-truth data is available for depth edges, a dedicated depth edge loss may be computed to encourage an MDE network to generate sharp discontinuities in the correct locations. However, due to the sparsity of ground-truth depth data for images in typical outdoor scenes (e.g., which may represent a target domain), obtaining accurate ground-truth edge data for the images may be challenging. Thus, the present disclosure proposes to use accurate, dense ground-truth depth data from a synthetic dataset (e.g., grand theft auto (GTA)) to train a DEE network to compute ground-truth edge data for training an MDE network.

The DEE network may infer probabilistic maps of depth edges on a training dataset for an MDE network (e.g., the training set of a target real domain). The probabilistic maps may then be used to guide an edge loss in the training of the MDE network. Although training on synthetic data and inferencing on real data may, in some cases, lead to poor performance due to a large domain gap, experiments demonstrate that the DEE network performs favorably in comparison to depth edges obtained from a baseline MDE network. The motivation to use the DEE network stems from an observation that predicting the absolute depth of each pixel (e.g., as performed by an MDE network) may be more difficult than predicting the location of depth edges in an input image (e.g., as performed by the DEE network).

Embodiments of the present disclosure provide a method to improve the localization of depth edges in MDE while preserving per-pixel depth accuracy. Embodiments of the present disclosure also provide a benchmark of human-annotated depth edges to evaluate the quality of depth edges computed by sparsely-supervised MDE algorithms. For instance, due to the lack of ground-truth depth edge data for evaluation in LIDAR-supervised real-world datasets, depth edges in evaluation sets may be manually annotated. These collected ground-truth depth edges may be used to show that an MDE trained using edge data generated by a DEE network may generate depth maps with significantly more accurate depth edges than other MDEs, while maintaining a similar depth accuracy.

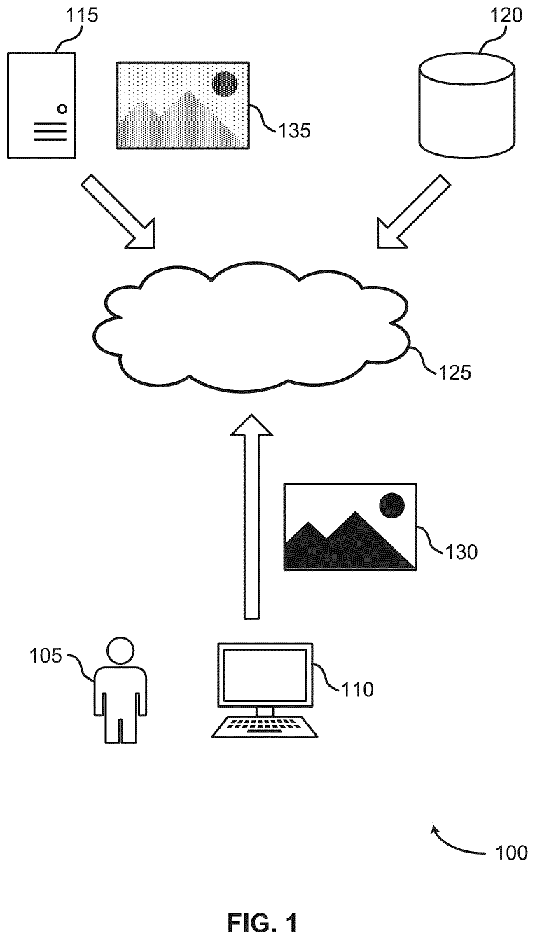

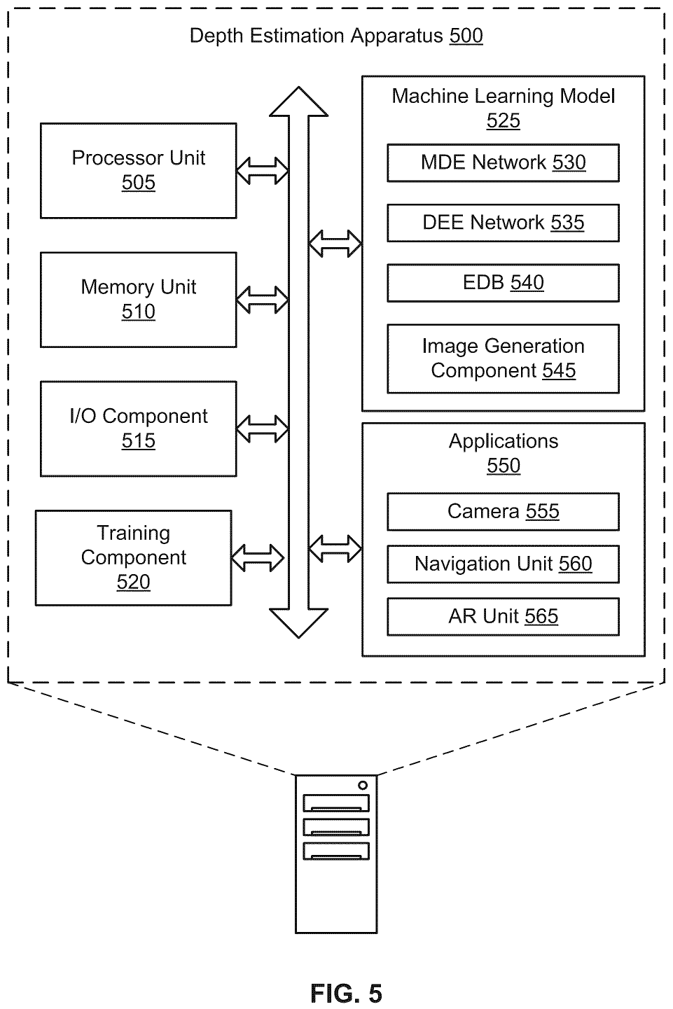

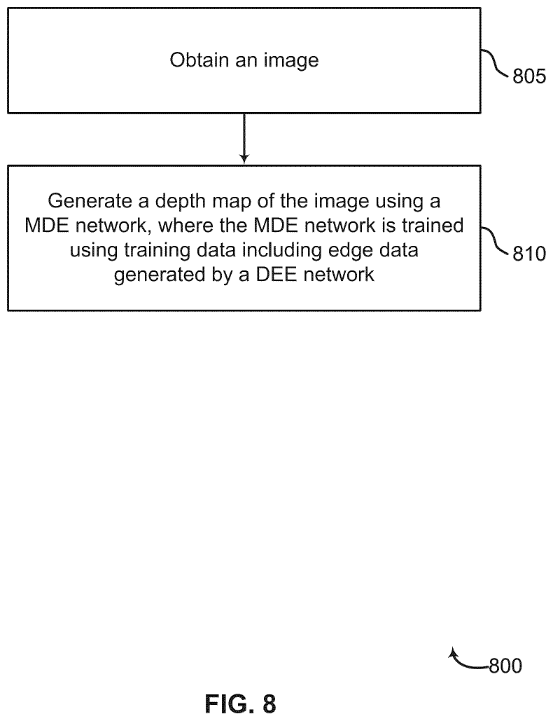

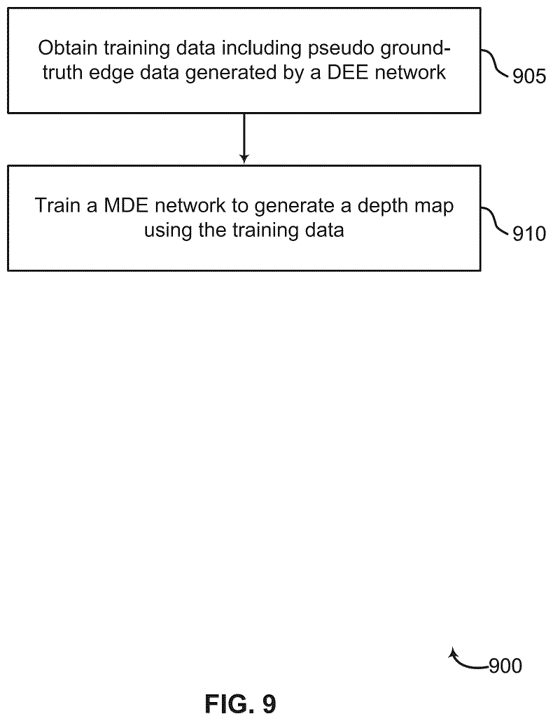

Details regarding a system for depth estimation are provided with reference to FIGS. 1-4. Details regarding architectures for depth estimation are provided with reference to FIGS. 5-7. An example inference process for depth estimation is provided with reference to FIG. 8. An example training process for depth estimation is provided with reference to FIG. 9.

### Depth Estimation System

FIG. 1 shows an example of a depth estimation system 100 according to aspects of the present disclosure. In one aspect, depth estimation system 100 includes user 105, user device 110, depth estimation apparatus 115, database 120, and cloud 125. Depth estimation apparatus 115 is an example of, or includes aspects of, the corresponding element described with reference to FIG. 5.

User 105 may interact with depth estimation software on user device 110. The user device 110 may communicate with the depth estimation apparatus 115 via the cloud 125. In some examples, user 105 or the user device 110 may provide an image 130 (e.g., an outdoor image) to the depth estimation apparatus 115, and the depth estimation apparatus 115 may generate a depth map 135 for the image 130. The depth map 135 may include relatively accurate depth edges since the depth estimation apparatus 115 may be trained using depth data and edge data. In some examples, the depth map 135 may be used in various applications, including robotic navigation, NVS, AR, etc.

MDE is a fundamental challenge in computer vision with numerous applications. In some examples, LIDAR-supervised methods may achieve remarkable per-pixel accuracy in outdoor scenes. However, significant errors are typically found in the proximity of depth edges (i.e., depth discontinuities), which often hinder the performance of depth-dependent applications that are sensitive to such inaccuracies (e.g., NVS and AR). Since direct supervision for the location of depth edges is typically unavailable in sparse LIDAR-based scenes, encouraging an MDE model to produce correct depth edges may not be straightforward.

The depth estimation apparatus 115 is capable of learning to detect the location of depth edges from densely-supervised synthetic data and using the learning to generate supervision for depth edges in MDE training. Despite the domain gap between synthetic data and real data, depth edges estimated directly may be significantly more accurate than depth edges that emerge indirectly from MDE training. To quantitatively evaluate the depth estimation apparatus 115, and due to the lack of ground truth depth edge data in LIDAR-based scenes, subsets of real datasets may be annotated with ground truth depth edges. Evaluation of the depth estimation apparatus 115 on several challenging datasets may show significant gains in the accuracy of depth edges generated by the depth estimation apparatus 115 with comparable per-pixel depth accuracy.

In some examples, depth estimators in some methods may be trained using full supervision with LIDAR or other absolute depth measurements, by self-supervision using two or more RGB images, or using semi-supervision. An objective of these methods is to reduce the overall mean absolute error (ARE), achieving impressive results.

In some examples, accurate depth estimation on object edges may be appropriate for specific applications such as AR. Such estimations could be improved when models are trained using dense ground truth depth maps, achieving impressive results. For example, training may be performed on indoor scenes using various datasets. Higher-range laser scanners or stereoscopic datasets may be used for generating dense depth maps for outdoor scenes. However, special and expensive setups may be appropriate for curating such datasets, and these setups may not be largely used for collecting data for automotive scenes. In some examples, other outdoor large-scale datasets may be created using stereoscopic publicly available movies with various scene types. However, without knowing an exact baseline and other camera characteristics, estimated depth maps (e.g., in accurate units) may not be constructed to a unified metric unit.

In some examples, to improve depth on object edges, specialized architectures and losses may be used. For example, depth maps may be estimated in an indoor scene with a focus on predicting occluding contours. A network may be first pretrained to predict occluding contours on synthetic data and fine-tuned on another dataset to constrain normal, depth and occluding contours. The network may also predict displacement fields of pixels with poorly predicted depth values of any dense map. In some examples, however, it may be appropriate to use dense ground truth depth maps to train the network. The depth estimation system 100 may be capable of improving all depth edges for outdoor scenes, where the ground truth maps are highly sparse. Other methods may use pseudo ground truth data based on disparity maps to guide training towards improved depth edges using a dedicated loss and semantic segmentation. However, it may be appropriate to collect disparity maps for training to facilitate such methods.

In some examples, a method may use semantic segmentation to define edge consistency between segmentation and depth maps. However, it may be appropriate to use segmentation maps for training in this method, which are expensive to create for large scale training datasets. The depth estimation system 100 may improve depth edges without this additional channel of information, while achieving a significantly lower ARE. In some examples, depth estimation models may be trained on datasets of three-dimensional (3D) movies. Although the depth estimation models may generate visually striking depth maps, without known baseline and camera parameters, the models may not predict absolute depth values.

In some examples, a method may blend an original predicted depth map with depth maps of a source image at different resolutions. The accuracy of this method may be evaluated using order ranking around depth edges, but some examples may not measure the absolute depth metrics on automotive related datasets. Some methods may boost resolution of depth maps from low resolution ones using, among others, an edge attention mechanism and high-quality images. In these methods, there may be co-occurrence between the texture edges of RGB images and depth edges. However, these methods may be fully supervised and trained on dense depth maps, making these methods impractical for outdoor images collected with sparse depth sensors.

In some examples, the depth estimation apparatus 115 may include a server. A server provides one or more functions to users (e.g., a user 105) linked by way of one or more of the various networks. In some cases, the server includes a single microprocessor board, which includes a microprocessor responsible for controlling all aspects of the server. In some cases, a server uses a microprocessor and protocols to exchange data with other devices/users on one or more of the networks via hypertext transfer protocol (HTTP), and simple mail transfer protocol (SMTP), although other protocols such as file transfer protocol (FTP), and simple network management protocol (SNMP) may also be used. In some cases, a server is configured to send and receive hypertext markup language (HTML) formatted files (e.g., for displaying web pages). In various embodiments, a server comprises a general-purpose computing device (e.g., user device 110), a personal computer, a laptop computer, a mainframe computer, a super computer, or any other suitable processing apparatus. A server may be, or may include, a powerful computer that hosts machine learning models and algorithms, making them accessible to other computers on a network (e.g., such as a user device 110). The server may also provide the computational power to handle the large amounts of data used in machine learning applications.

A database 120 is an organized collection of data. For example, a database 120 stores data in a specified format known as a schema. A database 120 may be structured as a single database, a distributed database, multiple distributed databases, or an emergency backup database. In some cases, a database controller may manage data storage and processing in a database. In some cases, a user 105 interacts with a database controller. In other cases, a database controller may operate automatically without user interaction. The database 120 may be used to store datasets used to train machine learning models. For instance, database 120 may provide a central location for storing and managing data, allowing for easier access and manipulation of the data during a model development process, during implementation of a machine learning task, etc.

A cloud 125 is a computer network configured to provide on-demand availability of computer system resources, such as data storage and computing power. In some examples, the cloud 125 provides resources without active management by the user 105. The term “cloud” is sometimes used to describe data centers available to many users over the Internet. Some large cloud networks have functions distributed over multiple locations from central servers. A server is designated as an edge server if the server has a direct or close connection to a user. In some cases, a cloud 125 is limited to a single organization. In other examples, the cloud 125 is available to many organizations. In one example, a cloud 125 includes a multi-layer communications network comprising multiple edge routers and core routers. In another example, a cloud 125 is based on a local collection of switches in a single physical location. In machine learning, cloud 125 may be used to host machine learning models and provide a scalable infrastructure for training and inference.

A user device 110 (e.g., a computing device) is a personal computer, laptop computer, mainframe computer, palmtop computer, personal assistant, mobile device, or any other suitable processing apparatus. In some aspects, the user device 110 may be used by a user 105 (e.g., a data scientist, machine learning engineer, etc.) for various computing tasks such as, for example, creating and testing machine learning models, performing machine learning tasks, implementing neural networks, etc. In some cases, the user device 110 may be a desktop computer or a laptop, equipped with powerful processors and graphics cards to handle the computational demands of machine learning.

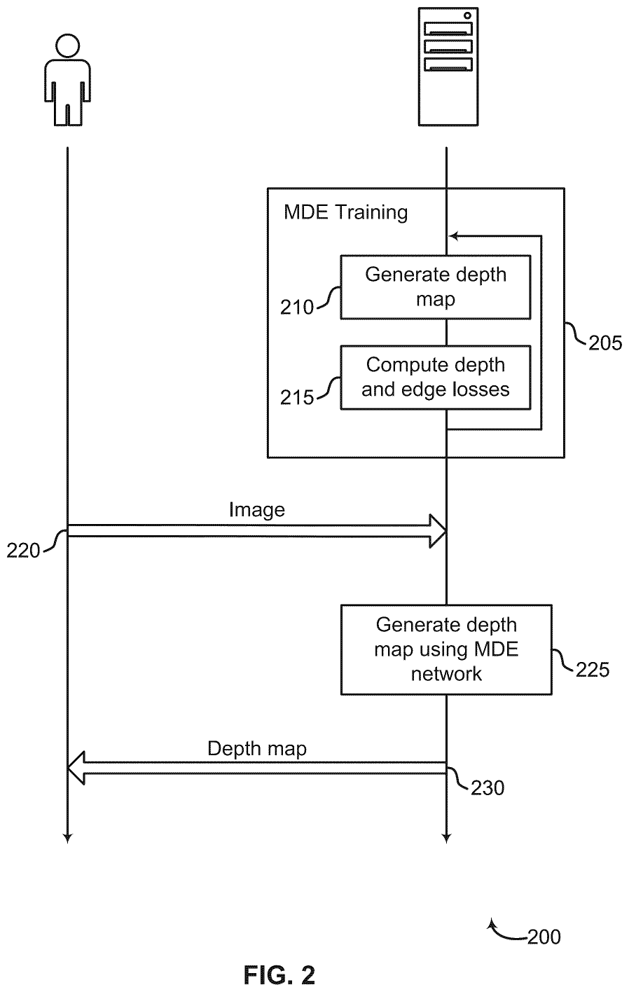

FIG. 2 shows an example of a method 200 for depth estimation according to aspects of the present disclosure. In some examples, these operations are performed by a system including a processor executing a set of codes to control functional elements of an apparatus. Additionally, or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

At operation 205, a depth estimation apparatus may train an MDE network to generate depth maps with accurate depth edges. In some cases, the operations of this step refer to, or may be performed by, a training component as described with reference to FIG. 5. Prior to training the MDE network, a DEE network may be trained using a source dataset (e.g., a synthetic dataset). The trained DEE network may then be used for inference (e.g., with multiscale output) on a training dataset of a target dataset (e.g., the real dataset for training the MDE network) to generate pseudo ground truth depth edges or edge data for training the MDE network. In some examples, the DEE network may be used to generate pseudo ground truth depth edges for multiple target datasets with the same characteristics.

At operation 210, during an iteration of training, the depth estimation apparatus may generate a depth map based on a training image. In some cases, the operations of this step refer to, or may be performed by, an MDE network as described with reference to FIG. 5. The depth map may indicate a depth for each pixel of the training image including pixels at various depth edges in the training image. In some examples, each training image may have a corresponding dense depth, semantic, and instance segmentation.

At operation 215, during an iteration of training, the depth estimation apparatus may compute depth and edge losses based on the depth map generated at operation 210. In some cases, the operations of this step refer to, or may be performed by, a training component as described with reference to FIG. 5. The training component may generate the depth losses by comparing the depth map generated at operation 210 for a training image with a ground truth depth map for the training image. In addition, the training component may generate the edge losses by computing depth edges based on the depth map generated at operation 210 for the training image and comparing the computed depth edges to pseudo ground truth depth edges for the training image (e.g., generated by a DEE network). The training component may then use the depth losses and edge losses to train an MDE network (e.g., by adjusting parameters of the MDE network based on the depth and edge losses).

At operation 220, a user provides an image to the depth estimation apparatus. In some cases, the operations of this step refer to, or may be performed by, a user as described with reference to FIG. 1. The user may provide the image to the depth estimation apparatus directly, or a user device may provide the image to the depth estimation apparatus to support an application (e.g., an AR or navigation application) being used by the user on the user device.

At operation 225, depth estimation apparatus generates a depth map using the MDE network trained at operation 205. In some cases, the operations of this step refer to, or may be performed by, an MDE network as described with reference to FIG. 5. Because the MDE network may be trained using an edge loss at operation 205 and may be guided to identify depth edges accurately, the resulting depth map generated by the MDE network may be sharper and thin objects may be more apparent. In addition, a 3D reconstruction (e.g., used for graphical applications) may produce less artifacts (e.g., floating points).

At operation 230, the depth estimation apparatus provides the depth map to the user. In some cases, the operations of this step refer to, or may be performed by, a depth estimation apparatus as described with reference to FIG. 1. In some examples, the depth estimation apparatus may provide the depth map to a user device for use by an application running on the user device (e.g., an AR or navigation application).

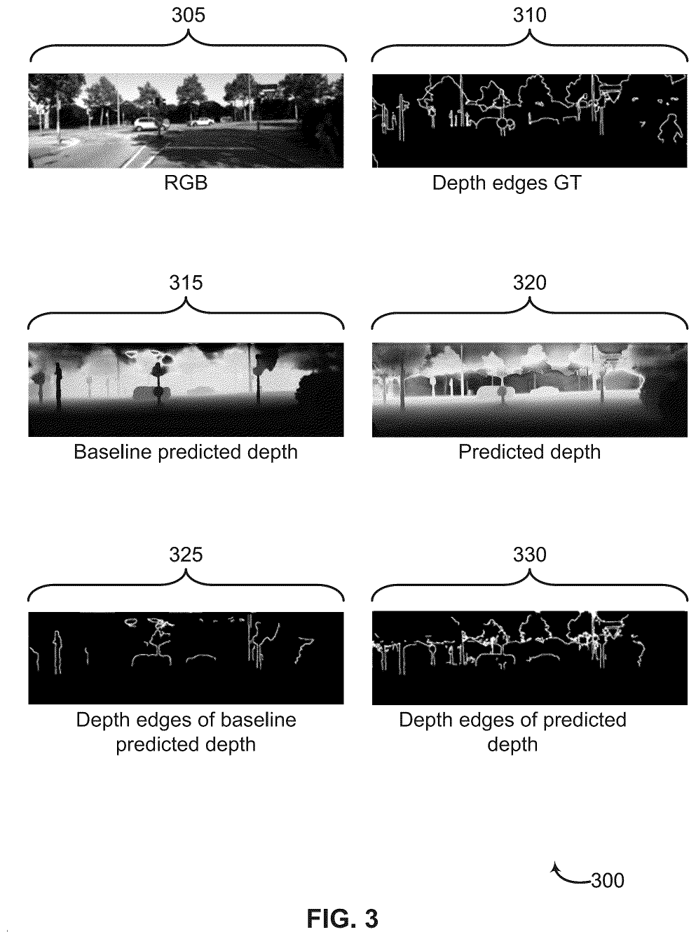

FIG. 3 shows example results 300 of depth estimation according to aspects of the present disclosure. The example results 300 show that many depth edges (e.g., on the silhouettes of objects) may be more accurate in a depth map (e.g., a depth estimation map) generated by a depth estimation apparatus described herein, and the depth map may be more complete as a result. The depth estimation apparatus may obtain a first RGB image 305 and may generate a depth map 320 showing the predicted depth of pixels in the first RGB image 305. The depth map 320 generated by the depth estimation apparatus may more accurately depict the depths of different pixels in the first RGB image 305 as can be seen in a comparison of the depth map 320 to another, baseline depth map 315. The depth edges 330 corresponding to the depth map 320 may also be more similar to the ground truth depth edges 310 than the depth edges 325 corresponding to the depth map 315.

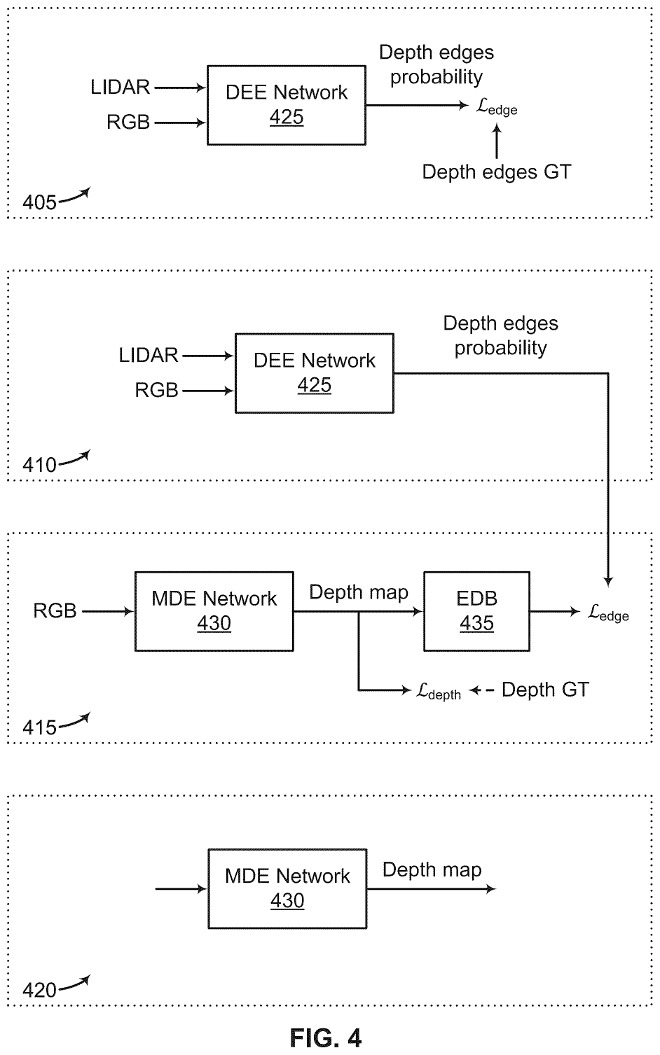

FIG. 4 shows an example of training and inference processes for depth estimation according to aspects of the present disclosure. The training flow for a depth estimation network may include three processes, and, after training, the depth estimation network may be used for inference in a fourth process. In a first process 405, a DEE network 425 is trained on a source dataset (e.g., synthetic dataset) with ground truth depth edges to predict a probabilistic map of depth edges for a given RGB image and a corresponding LIDAR image. In a second process 410, inference is applied on the training set of a target real dataset using the trained DEE network 425, resulting in (approximate) depth edge labels \tilde{E}_{GT}. In a third process 415, the MDE network 430 is trained with an EDB 435 to improve the localization of depth edges. The training is carried out using a straightforward supervised depth loss with LIDAR data as the ground truth and the proposed edge loss with \tilde{E}_{GT} as the approximate ground truth. In a fourth process, the MDE network 430 is used to generate depth maps with accurate depth edges based on input images.

MDE networks are commonly trained to regress per-pixel depth D(I) from an RGB image I given a depth ground truth D_{GT} in scales S using a loss function:

$$ℒ = \frac{1}{S} {\sum }_{S} {ℒ}_{d e p t h} ( {D}^{S} ( I ) , {D}_{G T}^{S} ) ,$$

where D^{s}(I) and D_{GT}^{s} indicate the predicted depth and ground truth depth in scale s, respectively. In some examples, the scale indexes may be omitted for brevity even though all losses may be multi-scale (e.g., unless explicitly stated).

To encourage the MDE network 430 to produce sharp edges at the correct locations, the EDB 435 (e.g., a differentiable layer) may be used that computes the per-pixel probability of depth edges \tilde{E}(D(I)) from the predicted depth map D(I), where I is the input RGB image. Given D(I), the EDB 435 computes the magnitude of the spatial image gradient |∇D(I)| and then transforms the magnitude into an edge-ness probability score: \tilde{E}(D(I))=sigmoid(|∇D(I)|−t_{grad}) by thresholding it with the parameter t_{grad} and passing it through a sigmoid function. In practice, when using the standard image gradient

$$\vert ∇ D ( I ) \vert = \sqrt{{( \frac{dD ( I )}{d x} )}^{2} + {( \frac{dD ( I )}{d y} )}^{2}} ,$$

some cyclic gradient patterns may emerge since both dD(I)/dx and dD(I)/dy are unconstrained.

Therefore, the gradient may be computed as a derivative in the direction perpendicular to the edge. To this end, the normal direction to the edge is first computed from the depth edge ground truth E_{GT} by:

$$θ = α tan 2 ( \frac{d {E}_{G T}}{d y} , \frac{d {E}_{G T}}{d x} ) .$$

The derivative in the direction perpendicular to the edge for every pixel (x, y) is therefore given by: ∇_{θ}D(I(x, y))=D(I(x+cos θ, y+sin θ))−D(I(x−cos θ, y−sin θ)), where the coordinates x±cos θ and y±sin θ are rounded in practice.

Given the depth edges ground truth \tilde{E}_{GT}, and the output of the EDB 435 \tilde{E}(D(I)), the following loss may be used to encourage sharp edges at \tilde{E}_{GT}: [symbol] _{edge}(DE(I), E_{GT})=BBCE(D_{E}(I), E_{GT}), where the BBCE is the balanced binary cross entropy loss where the positives (edge pixels) and the negatives (non-edge pixels) are reweighted in a standard BCE loss so they have equal contribution. The MDE network 430 is trained with a linear combination of the edge loss [symbol] _{edge} and the standard depth loss [symbol] _{depth}. The total loss is given by [symbol] = [symbol] _{depth}(D(I), D_{GT})+α [symbol] _{edge}(D_{E}(I) E_{GT}), where α (e.g., α=0.1) is a parameter to balance between the two losses, and D_{GT} is the depth ground truth.

Since the actual depth edges ground truth may be unavailable for a target real dataset, the DEE network 425 may be used to predict depth edges \tilde{E}(I, D′) from RGB I and LIDAR D′. The LIDAR measurements may have significant impact on the performance of the DEE network 425 when given as input in addition to an RGB. In order to train the DEE network 425, a synthetic dataset may be used with dense depth and LIDAR that are available for each RGB image. To extract depth edges ground truth E_{GT} for training the DEE network 425, an edge detector may be used on the dense depth ground truth. The DEE network 425 is trained with an edge loss similar to [symbol] _{edge} described above, but without the EDB 435 (e.g., [symbol] _{edge}(\tilde{E}(I, D′), E_{GT})). The loss may be applied for all scales of the outputs in the decoder.

The predicted depth edges \tilde{E}(I, D′) obtained from the DEE network 425 may be dense with Gaussian-like distributions. To produce sharp edges that are one pixel wide, two standard post-processing operations may be used: non-maximum suppression (NMS) and hysteresis (e.g., with 0.85 and 0.9 as low and high parameters, respectively).

### Network Architecture

In FIGS. 5-7, a method, apparatus, non-transitory computer-readable medium, and system for machine learning for image processing are described. One or more aspects of the method, apparatus, non-transitory computer-readable medium, and system include at least one memory component; at least one processing device coupled to the at least one memory component, wherein the at least one processing device is configured to execute instructions stored in the at least one memory component; and a MDE network configured to generate a depth map of an image, wherein the MDE network is trained using training data including edge data generated by a DEE network.

In some aspects, the method, apparatus, non-transitory computer-readable medium, and system further comprises a camera configured to obtain the image. In some aspects, the method, apparatus, non-transitory computer-readable medium, and system further comprises a navigation unit configured to generate navigation information based on the depth map. In some aspects, the method, apparatus, non-transitory computer-readable medium, and system further comprises an AR unit configured to display an AR object based on the depth map.

In some aspects, the method, apparatus, non-transitory computer-readable medium, and system further comprises the DEE network. In some aspects, the method, apparatus, non-transitory computer-readable medium, and system further comprises an EDB configured to generate predicted edge data based on the depth map. In some aspects, the method, apparatus, non-transitory computer-readable medium, and system further comprises an image generation component configured to generate a synthetic image, wherein the DEE network is trained based on the synthetic image.

FIG. 5 shows an example of a depth estimation apparatus 500 according to aspects of the present disclosure. Depth estimation apparatus 500 is an example of, or includes aspects of, the corresponding element described with reference to FIG. 1. In one aspect, depth estimation apparatus 500 includes processor unit 505, memory unit 510, I/O component 515, training component 520, machine learning model 525, and applications 550. In one aspect, machine learning model 525 includes MDE network 530, DEE network 535, EDB 540, and image generation component 545. In one aspect, applications 550 include camera 555, navigation unit 560, and AR unit 565.

The depth estimation apparatus 500 may implement a method to improve the localization of depth edges in the predictions of sparsely supervised MDE methods, while preserving the per-pixel accuracy. The method is based on the observation that detecting the location of depth edges may be easier than MDE. Therefore, learning DEE on synthetic data and transferring the results to real data can provide significant gains in comparison to depth edges that emerge in other MDE methods. To evaluate the method on real data, depth edges in an evaluation set may be generated by manual annotation. The evaluation set may become a standard benchmark to be used to evaluate depth edges in addition to standard per-pixel evaluation. In some examples, the method implemented by the depth estimation apparatus 500 may be further improved by considering images (and LIDAR) of a target dataset in a training procedure (e.g., in an unsupervised manner).

Processor unit 505 comprises a processor. Processor unit 505 is an intelligent hardware device (e.g., a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or any combination thereof). An intelligent hardware device may refer to a physical device that is equipped with computing capabilities, artificial intelligence algorithms, or connectivity features to perform various tasks with minimal human intervention. In some cases, the processor unit 505 is configured to operate a memory array using a memory controller. In other cases, a memory controller is integrated into the processor unit 505. In some cases, the processor unit 505 is configured to execute computer-readable instructions stored in a memory to perform various functions. In some embodiments, a processor unit 505 includes special-purpose components for modem processing, baseband processing, digital signal processing, or transmission processing.

Memory unit 510 comprises a memory including instructions executable by the processor. Examples of a memory unit 510 include random access memory (RAM), read-only memory (ROM), or a hard disk. Examples of memory units include solid state memory and a hard disk drive. In some examples, memory is used to store computer-readable, computer-executable software including instructions that, when executed, cause a processor to perform various functions described herein. In some cases, the memory unit 510 contains, among other things, a basic input/output system (BIOS) which controls basic hardware or software operation such as the interaction with peripheral components or devices. In some cases, a memory controller operates memory cells. For example, the memory controller can include a row decoder, column decoder, or both. In some cases, memory cells within a memory unit 510 store information in the form of a logical state.

I/O component 515 (e.g., an input/output interface) may include an I/O controller. An I/O controller may manage input and output signals for a device. I/O controller may also manage peripherals not integrated into a device. In some cases, an I/O controller may represent a physical connection or port to an external peripheral. In some cases, an I/O controller may utilize an operating system such as iOS®, ANDROID®, MS-DOS®, MS-WINDOWS®, OS/2®, UNIX®, LINUX®, or another known operating system. In other cases, an I/O controller may represent or interact with a modem, a keyboard, a mouse, a touchscreen, or a similar device. In some cases, an I/O controller may be implemented as part of a processor. In some cases, a user may interact with a device via I/O controller or via hardware components controlled by an I/O controller.

In some examples, I/O component 515 includes a user interface. A user interface may enable a user to interact with a device. In some embodiments, the user interface may include an audio device, such as an external speaker system, an external display device such as a display screen, or an input device (e.g., remote-control device interfaced with the user interface directly or through an I/O controller module). In some cases, a user interface may be a graphical user interface (GUI). In some examples, a communication interface operates at the boundary between communicating entities and the channel and may also record and process communications. Communication interface is provided herein to enable a processing system coupled to a transceiver (e.g., a transmitter and/or a receiver). In some examples, the transceiver is configured to transmit (or send) and receive signals for a communications device via an antenna.

In some examples, depth estimation apparatus 500 includes a computer-implemented artificial neural network (ANN) to generate classification data, prediction data, or regression data for a set of samples. An ANN is a hardware or a software component that includes a number of connected nodes (i.e., artificial neurons), which loosely correspond to the neurons in a human brain. Each connection, or edge, transmits a signal from one node to another (like the physical synapses in a brain). When a node receives a signal, the node processes the signal and then transmits the processed signal to other connected nodes. In some cases, the signals between nodes comprise real numbers, and the output of each node is computed by a function of the sum of its inputs. Each node and edge is associated with one or more node weights that determine how the signal is processed and transmitted.

In some examples, depth estimation apparatus 500 includes a computer-implemented convolutional neural network (CNN). A CNN is a class of neural network that is commonly used in computer vision or image classification systems. In some cases, a CNN may enable processing of digital images with minimal pre-processing. A CNN may be characterized by the use of convolutional (or cross-correlational) hidden layers. These layers apply a convolution operation to the input before signaling the result to the next layer. Each convolutional node may process data for a limited field of input (i.e., the receptive field). During a forward pass of the CNN, filters at each layer may be convolved across the input volume, computing the dot product between the filter and the input. During the training process, the filters may be modified so that they activate when they detect a particular feature within the input.

In some examples, depth estimation apparatus 500 includes a transformer. A transformer or transformer network is a type of neural network model used for natural language processing tasks. A transformer network transforms one sequence into another sequence using an encoder and a decoder. The encoder and decoder include modules that can be stacked on top of each other multiple times. The modules comprise multi-head attention and feedforward layers. The inputs and outputs (target sentences) are first embedded into an n-dimensional space. Positional encoding of the different words (i.e., give every word/part in a sequence a relative position since the sequence depends on the order of its elements) is added to the embedded representation (n-dimensional vector) of each word. In some examples, a transformer network includes attention mechanism, where the attention looks at an input sequence and decides at each step which other parts of the sequence are important. The attention mechanism involves query, keys, and values denoted by Q, K, and V, respectively. Q corresponds to a matrix that contains the query (vector representation of one word in the sequence), K corresponds to all the keys (vector representations of all the words in the sequence), and V corresponds to the values, which are again the vector representations of all the words in the sequence. For the encoder and decoder, multi-head attention modules, V consists of the same word sequence as Q. However, for the attention module that is taking into account the encoder and the decoder sequences, V is different from the sequence represented by Q. In some cases, values in V are multiplied and summed with some attention-weights a.

In some examples, the training component 520 is implemented as software stored in memory and executable by a processor of a separate computing device, as firmware in the separate computing device, as one or more hardware circuits of the separate computing device, or as a combination thereof. In some examples, training component 520 is part of another apparatus other than depth estimation apparatus 500 and communicates with the depth estimation apparatus 500.

According to some aspects, MDE network 530 obtains an image. In some examples, MDE network 530 generates a depth map of the image network, where the MDE network 530 is trained using training data including edge data generated by a DEE network 535.

According to some aspects, an application 550 displays a boundary of an object based on the depth map. According to some aspects, navigation unit 560 generates navigation information based on the depth map. According to some aspects, AR unit 565 displays an AR object based on the depth map, where the AR object is partially occluded based on an object in the image. According to some aspects, camera 555 captures the image located in a same device as the MDE network 530. In some aspects, the depth map includes a depth estimation for a pixel of the image, and the edge data includes a probability of an edge for a pixel of a training image.

According to some aspects, training component 520 obtains training data including pseudo ground-truth edge data generated by a DEE network 535. In some examples, training component 520 trains an MDE network 530 to generate a depth map using the training data.

According to some aspects, EDB 540 generates predicted edge data based on the depth map. In some examples, training component 520 computes an edge loss based on the predicted edge data and the pseudo ground-truth edge data, where the MDE network 530 is trained based on the edge loss. In some aspects, the edge loss includes a BCE loss.

In some examples, training component 520 computes a depth loss based on the depth map, where the MDE network 530 is trained based on the depth loss. In some examples, training component 520 obtains ground truth depth information, where the depth loss is based on the ground truth depth information. According to some aspects, DEE network 535 obtains synthetic training data including a synthetic image and synthetic edge data. In some examples, the image generation component 545 generates the synthetic image. In some examples, training component 520 trains the DEE network 535 based on the synthetic training data. In some examples, DEE network 535 obtains a real image. In some examples, DEE network 535 generates the pseudo ground-truth edge data based on the real image after training the DEE network 535.

The field of MDE has been gaining considerable attention, where solutions that use CNNs may be shown to outperform other approaches. In particular, solutions that use a U-Net architecture may achieve good results. U-Net is a form of encoder-decoder architecture that is composed of an encoder followed by a decoder. An encoder takes an RGB image as input and encodes it into a low-dimensional image (e.g., 1/16 of the RGB image in each axis) using a series of layers. The series of layers may include a convolution layer (e.g., with a stride of two to down-sample the image by a factor of two), a non-linearity layer (e.g., ReLU), and a normalization layer (e.g., BatchNorm). A decoder may be somewhat of a reflection of the encoder, with similar layers, except for layers (e.g., transpose convolution) that up-sample the image. Finally, on top of the encoder-decoder architecture, a U-Net may have residual connections between layers of the same spatial size in the encoder and the decoder, which is a common solution to training stability problems in neural networks, as used in residual neural networks (ResNets).

In some outdoor scenes used to train MDE networks, each RGB image I may have a corresponding annotated sparse depth ground truth D_{GT}, which is the product of synchronizing LIDAR measurements and an RGB image. A network D receives I and produces a corresponding dense depth D(I). During training, D is guided to decrease the loss [symbol] _{depth}, which is some function of D(I) and D_{GT} (e.g. [symbol] _{depth}=|D(I)−D_{GT}℄). In some cases, the loss [symbol] _{depth} may be computed only in pixels that have valid depth in D_{GT}. Since standard loss functions (e.g., L₁ and L₂) may equally weigh errors that are close to a camera and errors that are far away, loss functions in log space are often used. One example for such a loss function is the scale invariant logarithmic error (SILog):

$$SI Log ( D ( I ) , {D}_{G T} ) = \frac{1}{n} {\sum }_{i , j} {( log D ( I ) [ i , j ] - log D ( I ) [ i , j ] )}^{2} - \frac{1}{{n}^{2}} {( {\sum }_{i , j} log D ( I ) [ i , j ] - log D ( I ) [ i , j ] )}^{2} ,$$

where n is the number of depth pixels in the ground truth. Since D_{GT} may be sparse, the loss [symbol] _{depth} may be computed in pixels that have valid depth.

There has been great progress in depth estimation from a single image using neural networks, such as an MDE network, resulting in a very low per-pixel mean error. However, the distribution of errors in an output of an MDE network may be far from uniform, where the error may be large in proximity of depth edges (e.g., depth discontinuities around the silhouette of objects), which may be referred to as smooth edges or incorrectly-located edges. Embodiments of the present disclosure may improve the sharpness and localization of depth edges in depth maps generated by an MDE system (e.g., an MDE system trained with sparse supervision). For instance, to predict a per-pixel depth, an MDE network may be trained with LIDAR measurements as ground truth, and, in addition to learning to predict the per-pixel depth, the MDE network may be directly encouraged to produce sharp edges at the correct locations.

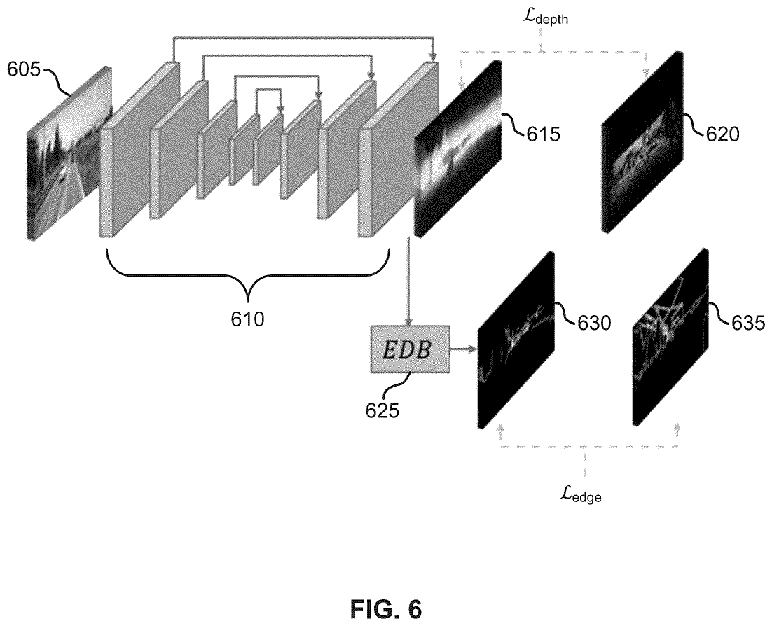

FIG. 6 shows an example of an MDE network during training according to aspects of the present disclosure. An MDE network 610 may obtain an RGB image 605 (e.g., a training image) and may generate a depth map 615 based on the RGB image (e.g., indicating the predicted depth of pixels in the RGB image 605). The depth map 615 may be compared to a ground truth depth map 620 (e.g., generated from LIDAR measurements) to compute a depth loss [symbol] _{depth}, and the MDE network 610 may be trained based on the depth loss (e.g., trained to minimize depth losses). An EDB 625 may also compute depth edges 630 based on the depth map 615, and the depth edges 630 may be compared to pseudo ground truth depth edges 635 to compute an edge loss [symbol] _{edge}. The MDE network 610 may then be trained based on the edge loss (e.g., trained to minimize edge losses). Thus, training of the MDE network 610 may be based on the MDE network 610 having access to depth edges ground truth data (e.g., the location of depth edges pixels E_{GT}). In some examples, the depth edges ground truth data (e.g., including the pseudo ground truth depth edges 635 for the RGB image 605) may be inferred using a DEE network.

The EDB 625 may be a differentiable layer that computes the locations of depth edges from a predicted depth map. The EDB 625 may compute the magnitude of a local image gradient |∇D(I)|₂ of the predicted depth map D(I) and then transform the magnitude to an edge-ness score EDB(D(I)=sigmoid(|∇D(I)|₂−t_{grad}), by thresholding the magnitude with t_{grad}=4 and passing the result through a sigmoid. In some examples, the standard image gradient

$${\vert ∇ D ( I ) \vert}_{2} = \sqrt{{( \frac{dD ( I )}{d x} )}^{2} + {( \frac{dD ( I )}{d y} )}^{2}}$$

may not be used, since it may result in significant artifacts when either dE_{GT}/dx or dE_{GT}/dy is close to zero (e.g., horizontal or vertical edges). Instead, a gradient direction may first be computed from ground truth data as follows:

$$θ = α tan 2 ( \frac{d {E}_{G T}}{d y} , \frac{d {E}_{G T}}{d x} ) .$$

An image gradient ∇D(I) may then be computed as the depth difference in the direction of θ. That is, ∀_{x,y∈D(I)}∇_{θ}D(I[x, y])=D(I[x+cos θ,y+sin θ])−D(I[x−cos θ, y−sin θ]), where the coordinates x±cos θ and y±sin θ may be rounded (or alternatively, used to interpolate D(I)).

Thus, the actual EDB is given by EDB(D(I))=sigmoid(|∇_{θ}D(I)|−t_{grad}). Then, given the depth edges ground truth E_{GT}={E_{GT}^{s}}_{s∈S}, for scales s∈S (e.g., where S={1, ½, ¼, ⅛}, the following loss may be used to encourage sharp edges at

$${E}_{G T} : {ℒ}_{e d g e} ( D ( I ) , {E}_{G T} ) = \frac{1}{\vert S \vert} {\sum }_{s ∈ S} BBCE ( ED B ( {D}^{S} ( I ) ) , {E}_{G T}^{S} ) ,$$

where BBCE is the standard binary cross entropy loss where the loss that corresponds to the positives (e.g., edge pixels) and to the negatives (e.g., non-edge pixels) is reweighted so they correspond to 50%-50% of the loss. That is, multiplying the loss of the positives by

$$β = \frac{\vert {Y}^{-} \vert}{\vert Y \vert} ,$$

where |Y⁻| and |Y| are the non-edge and all pixels, respectively. The loss of the negatives, or more particularly, the factor to multiply the loss of the negatives, is given by 1−β. Note that in addition to the proposed edge loss [symbol] _{edge}, the standard depth loss [symbol] _{depth} is used. In some examples, a (per-pixel) cross entropy loss used by an EDB may result in some artifacts (e.g., ringing near edges), and the loss may be inherently limited in its ability to augment depth edges that are considerably far from the ground truths. In some examples, non-pixelwise losses may be used to augment these depth edges more effectively.

Since the depth ground truth in real outdoor scenes may be sparse (e.g., 1-4% of the pixels may have valid depth), it may not be straightforward to obtain depth edges ground truth E_{GT}. Embodiments of the present disclosure provide for training a DEE network (e.g., a neural network) to predict the location of depth edges from RGB and LIDAR measurements. The DEE network may then be used to pseudo annotate a training dataset for an MDE network 610 (e.g., the real dataset) with approximate ground truth depth edge data (e.g., pseudo ground-truth edge data). The DEE network may be trained on a dataset (e.g., a synthetic dataset) with similar characteristics as the training dataset for the MDE network 610 and per-pixel dense depth ground truth data. In some examples, the DEE network may be a U-Net architecture. The U-Net architecture may include a sparse encoder for a sparse LIDAR signal, which uses sparse layers (e.g., sparse convolutions), and which may be suitable for MDE as well as for depth edge estimation.

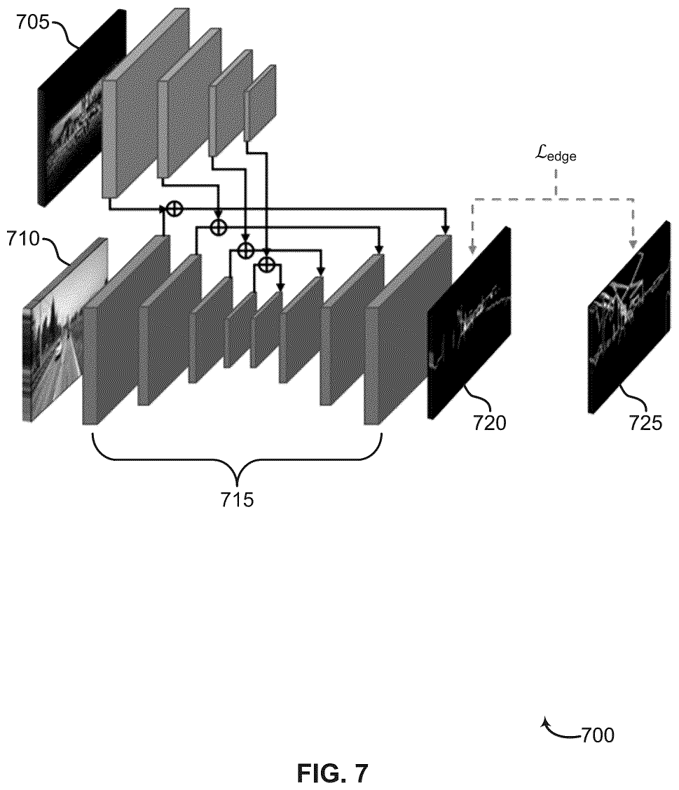

FIG. 7 shows an example of a DEE network during training according to aspects of the present disclosure. The DEE network 715 may be trained to detect depth edges on a synthetic dataset that has RGB images and corresponding dense depth ground truth data and LIDAR measurements. The synthetic dataset may be referred to as a source dataset. In an iteration of training, the DEE network 715 may obtain a LIDAR image 705 and an RGB image 710, and the DEE network 715 may generate depth edges 720 (e.g., predicted depth edges). The depth edges 720 may then be compared to ground truth depth edges 725 for the LIDAR image 705 and the RGB image 710 to compute an edge loss [symbol] _{edge}, and the DEE network 715 may be trained based on the edge loss (e.g., trained to minimize edge losses). To extract depth edges ground truth data E_{GT} (e.g., the ground truth depth edges 725), an edge detector may be used on the depth ground truth from the source dataset (e.g., the depth ground truth for the LIDAR image 705 and the RGB image 710).

Similar to the MDE network, the loss used for training the DEE network 715 E may be a BalancedBinaryCrossEntropy loss. One difference is that no differentiable edge detection (e.g., EDB) is used in training the DEE network 715. Given the depth edges ground truth E_{GT}={E_{GT}^{s}}_{s∈S}, for scales s∈S (e.g., where S={1, ½, ¼, ⅛}), the edge loss [symbol] _{edge}(E(I), E_{GT}) is given by:

$${ℒ}_{e d g e} ( E ( I ) , {E}_{G T} ) = \frac{1}{\vert S \vert} {\sum }_{s ∈ S} BBCE ( {E}^{S} ( I ) , {E}_{G T}^{S} ) ,$$

where E^{s}(I) is the output of the DEE network 715 applied on image I for scale s∈S. The DEE network 715 may follow a U-Net architecture, which is often used for dense prediction tasks such as MDE. One addition to the standard U-Net is a sparse encoder used to encode the LIDAR signal, which uses suitable sparse layers (e.g., sparse convolutions).

After the DEE network 715 is trained, inference is carried out on the training set of the real dataset to (pseudo) annotate the training set for depth estimation. The training set of the real dataset may be referred to as a target dataset. Inference may be done by forwarding an RGB image I and the corresponding LIDAR image L through the DEE network 715 E (i.e., E(I, L)). Then, NMS may be carried out on E(I, L). NMS may include computing an orientation map of the normal to the edges Ê_{GT}:

$$θ = α tan 2 ( \frac{d {\hat{E}}_{G T}}{d v} , \frac{d {\hat{E}}_{G T}}{d x} ) .$$

Then, for x, y∈Ê_{GT}, if Ê_{GT}[x, y]>Ê_{GT}[x+cos θ, y+sin θ] and Ê_{GT}[x, y]>Ê_{GT}[x−cos θ, y−sin θ], mark x, y as an edge pixel. Otherwise, mark x, y as a non-edge pixel.

### Inference

In FIG. 8, a method, apparatus, non-transitory computer-readable medium, and system for depth estimation are described. One or more aspects of the method, apparatus, non-transitory computer-readable medium, and system include obtaining an image and generating a depth map of the image using a MDE network, wherein the MDE network is trained using training data including edge data generated by a DEE network.

Some examples of the method, apparatus, non-transitory computer readable medium, and system further include displaying a boundary of an object based on the depth map. Some examples of the method, apparatus, non-transitory computer readable medium, and system further include generating navigation information based on the depth map.

Some examples of the method, apparatus, non-transitory computer readable medium, and system further include displaying an AR object based on the depth map, wherein the AR object is partially occluded based on an object in the image. Some examples of the method, apparatus, non-transitory computer readable medium, and system further include capturing the image using a camera located in a same device as the MDE network. In some aspects, the depth map comprises a depth estimation for a pixel of the image, and the edge data includes a probability of an edge for a pixel of a training image.

FIG. 8 shows an example of a method 800 for machine learning according to aspects of the present disclosure. In some examples, these operations are performed by a system including a processor executing a set of codes to control functional elements of an apparatus. Additionally, or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

At operation 805, the system obtains an image. The image may be an RGB image depicting various objects at different depths or distances from a source (e.g., a camera). In some cases, the operations of this step refer to, or may be performed by, an MDE network as described with reference to FIG. 5.

At operation 810, the system generates a depth map of the image using an MDE network, where the MDE network is trained using training data including edge data generated by a DEE network. The depth map may specify an estimated depth of each pixel of the image, and, because the MDE network may be trained using training data that includes edge data, the estimated depth of pixels on and around depth edges in the depth map may be more accurate. In some cases, the operations of this step refer to, or may be performed by, an MDE network as described with reference to FIG. 5.

### Training

In FIG. 9, a method, apparatus, non-transitory computer-readable medium, and system for depth estimation are described. One or more aspects of the method, apparatus, non-transitory computer-readable medium, and system include obtaining training data including pseudo ground-truth edge data generated by a DEE network and training a MDE network to generate a depth map using the training data.

Some examples of the method, apparatus, non-transitory computer readable medium, and system further include generating predicted edge data based on the depth map. Some examples further include computing an edge loss based on the predicted edge data and the pseudo ground-truth edge data, wherein the MDE network is trained based on the edge loss.

In some aspects, the edge loss comprises a balanced BCE loss. Some examples of the method, apparatus, non-transitory computer readable medium, and system further include computing a depth loss based on the depth map, wherein the MDE network is trained based on the depth loss. Some examples of the method, apparatus, non-transitory computer readable medium, and system further include obtaining ground truth depth information, wherein the depth loss is based on the ground truth depth information.

Some examples of the method, apparatus, non-transitory computer readable medium, and system further include obtaining synthetic training data including a synthetic image and synthetic edge data. Some examples further include training the DEE network based on the synthetic training data. Some examples of the method, apparatus, non-transitory computer readable medium, and system further include obtaining a real image. Some examples further include generating the pseudo ground-truth edge data based on the real image after training the DEE network.

FIG. 9 shows an example of a method 900 for machine learning according to aspects of the present disclosure. In some examples, these operations are performed by a system including a processor executing a set of codes to control functional elements of an apparatus. Additionally, or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

At operation 905, the system obtains training data including pseudo ground-truth edge data generated by a DEE network. The pseudo ground-truth edge data may refer to estimated locations of depth edges in each image of the training data as determined by the DEE network. In some cases, the operations of this step refer to, or may be performed by, a training component as described with reference to FIG. 5.

At operation 910, the system trains a MDE network to generate a depth map using the training data. The depth map may specify an estimated depth of each pixel of an image, and, because the MDE network may be trained using training data that includes edge data, the estimated depth of pixels on and around depth edges in the depth map may be more accurate. In some cases, the operations of this step refer to, or may be performed by, a training component as described with reference to FIG. 5.

The description and drawings described herein represent example configurations and do not represent all the implementations within the scope of the claims. For example, the operations and steps may be rearranged, combined or otherwise modified. Also, structures and devices may be represented in the form of block diagrams to represent the relationship between components and avoid obscuring the described concepts. Similar components or features may have the same name but may have different reference numbers corresponding to different figures.

Some modifications to the disclosure may be readily apparent to those skilled in the art, and the principles defined herein may be applied to other variations without departing from the scope of the disclosure. Thus, the disclosure is not limited to the examples and designs described herein, but is to be accorded the broadest scope consistent with the principles and novel features disclosed herein.

The described systems and methods may be implemented or performed by devices that include a general-purpose processor, a digital signal processor (DSP), an application specific integrated circuit (ASIC), a field programmable gate array (FPGA) or other programmable logic device, discrete gate or transistor logic, discrete hardware components, or any combination thereof. A general-purpose processor may be a microprocessor, a conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Thus, the functions described herein may be implemented in hardware or software and may be executed by a processor, firmware, or any combination thereof. If implemented in software executed by a processor, the functions may be stored in the form of instructions or code on a computer-readable medium.

Computer-readable media includes both non-transitory computer storage media and communication media including any medium that facilitates transfer of code or data. A non-transitory storage medium may be any available medium that can be accessed by a computer. For example, non-transitory computer-readable media can comprise random access memory (RAM), read-only memory (ROM), electrically erasable programmable read-only memory (EEPROM), compact disk (CD) or other optical disk storage, magnetic disk storage, or any other non-transitory medium for carrying or storing data or code.

Also, connecting components may be properly termed computer-readable media. For example, if code or data is transmitted from a website, server, or other remote source using a coaxial cable, fiber optic cable, twisted pair, digital subscriber line (DSL), or wireless technology such as infrared, radio, or microwave signals, then the coaxial cable, fiber optic cable, twisted pair, DSL, or wireless technology are included in the definition of medium. Combinations of media are also included within the scope of computer-readable media.

In this disclosure and the following claims, the word “or” indicates an inclusive list such that, for example, the list of X, Y, or Z means X or Y or Z or XY or XZ or YZ or XYZ. Also the phrase “based on” is not used to represent a closed set of conditions. For example, a step that is described as “based on condition A” may be based on both condition A and condition B. In other words, the phrase “based on” shall be construed to mean “based at least in part on.” Also, the words “a” or “an” indicate “at least one.”

1. A method comprising:
obtaining an image; and
generating a depth map of the image using a monocular depth estimation (MDE) network, wherein the MDE network is trained using training data including edge data generated by a depth edge estimation (DEE) network.

2. The method of claim 1, further comprising:
displaying a boundary of an object based on the depth map.

3. The method of claim 1, further comprising:
generating navigation information based on the depth map.

4. The method of claim 1, further comprising:
displaying an augmented reality (AR) object based on the depth map, wherein the AR object is partially occluded based on an object in the image.

5. The method of claim 1, further comprising:
capturing the image using a camera located in a same device as the MDE network.

6. The method of claim 1, wherein:
the depth map comprises a depth estimation for a pixel of the image, and the edge data includes a probability of an edge for a pixel of a training image.

7. A method comprising:
obtaining training data including pseudo ground-truth edge data generated by a depth edge estimation (DEE) network; and
training a monocular depth estimation (MDE) network to generate a depth map using the training data.

8. The method of claim 7, further comprising:
generating predicted edge data based on the depth map; and
computing an edge loss based on the predicted edge data and the pseudo ground-truth edge data, wherein the MDE network is trained based on the edge loss.

9. The method of claim 8, wherein:
the edge loss comprises a balanced binary cross entropy (BCE) loss.

10. The method of claim 7, further comprising:
computing a depth loss based on the depth map, wherein the MDE network is trained based on the depth loss.

11. The method of claim 10, further comprising:
obtaining ground truth depth information, wherein the depth loss is based on the ground truth depth information.

12. The method of claim 7, further comprising:
obtaining synthetic training data including a synthetic image and synthetic edge data; and
training the DEE network based on the synthetic training data.

13. The method of claim 7, further comprising:
obtaining a real image; and
generating the pseudo ground-truth edge data based on the real image after training the DEE network.

14. An apparatus comprising:
at least one memory component;
at least one processing device coupled to the at least one memory component, wherein the at least one processing device is configured to execute instructions stored in the at least one memory component; and
a monocular depth estimation (MDE) network configured to generate a depth map of an image, wherein the MDE network is trained using training data including edge data generated by a depth edge estimation (DEE) network.

15. The apparatus of claim 14, wherein the apparatus further comprises a camera configured to obtain the image.

16. The apparatus of claim 14, wherein the apparatus further comprises a navigation unit configured to generate navigation information based on the depth map.

17. The apparatus of claim 14, wherein the apparatus further comprises an augmented reality (AR) unit configured to display an AR object based on the depth map.

18. The apparatus of claim 14, wherein the apparatus further comprises the DEE network.

19. The apparatus of claim 14, wherein the apparatus further comprises an edge detection block (EDB) configured to generate predicted edge data based on the depth map.

20. The apparatus of claim 14, wherein the apparatus further comprises an image generation component configured to generate a synthetic image, wherein the DEE network is trained based on the synthetic image.
